(19) United States
(12) Patent Application Publication
(10) Pub. No.: US 2011/0316289 A1
(43) Pub. Date: Dec. 29, 2011

(54) BICYCLE WITH A FLYWHEEL ACCESSORY FOR GENERATING ELECTRICAL POWER

(76) Inventor: Gregory Trimarche, Laguna Beach, CA (US)

(21) Appl. No.: 13/113,910

(22) Filed: May 23, 2011

Related U.S. Application Data
(60) Provisional application No. 61/347,791, filed on May 24, 2010.

(51) Int. Cl. F03G 5/06

(52) U.S. Cl. 290/1 D

(57) ABSTRACT

Eco-friendly transport means including mechanisms to generate, transport and buffer/store energy.

### STATEMENT OF PRIORITY AND CROSS-REFERENCE TO RELATED APPLICATIONS UNDER THE PARIS CONVENTION

The instant filing requesting grant of Letters Patent claims full Paris Convention Priority from U.S. Provisional Patent Application Ser. No. 61/347,791, filed May 24, 2010 in the name of the present inventor, and which is expressly incorporated herein by reference as if fully set forth herein.

### BACKGROUND OF THE INVENTION

### Field of the Disclosure

The present disclosure relates generally to renewable resources for generating electricity. The disclosure more specifically relates to a bicycle with a flywheel accessory for generating mechanical energy that gets converted into electrical power.

### SUMMARY

Briefly stated, Eco-friendly transport means including mechanisms to generate, transport and buffer/store energy. An outdoor source for the generation of electrical power is disclosed. The source of the electrical power is the conversion of mechanical energy of a flywheel into electrical energy. This electrical energy can then be used to power many popular devices. According to some exemplary implementations, disclosed is an outdoor electrical charger, comprising: a flywheel, a hand crank or some device to turn the flywheel, a chain connecting the flywheel and the hand crank such that the flywheel can be rotated at high speeds when the hand crank is turned; a power generator coupled to the flywheel such that the rotation of the flywheel will cause the power generator to generate electrical power; a storage battery electrically coupled to the power generator; and an electrical output electrically coupled to the storage battery. The electrical output may be adapted to charge a cellular phone or an MP3 player. The electrical output may be adapted to charge a laptop computer. In addition, the electrical output may be adapted to power a radio and speakers.

According to some exemplary implementations, disclosed is a bicycle comprising: a frame assembly including a seat assembly; a handlebar assembly, the handlebar assembly rotatably coupled to the frame; a drive assembly; a wheel assembly, the wheel assembly rotatably coupled to the frame and coupled to the drive assembly; a flywheel assembly including a flywheel axle and a flywheel attached to the flywheel axle; a slip clutch coupled to the flywheel axle and the drive assembly; a mounting bearing to secure the flywheel assembly to the frame such that the flywheel maintains contact with the rear wheel; and a power generator coupled to the flywheel such that the rotation of the flywheel will cause the power generator to generate electrical power. The electrical power may be stored in a battery that is electrically connected to the power generator and mounted on the frame assembly. An electrical charger may be connected to the battery and mounted under the seat of the bicycle. The electrical charger may be used to recharge a cellular phone or an Ipod.

According to some exemplary embodiments, disclosed is a method for generating electricity while riding a bicycle comprising, in combination, providing a frame assembly including: providing a seat assembly; providing a handlebar assembly; providing a drive assembly; and providing a wheel assembly, the wheel assembly rotatably coupled to the frame and coupled to the drive assembly; providing a flywheel assembly including providing a flywheel axle, and providing a flywheel attached to the flywheel axle; providing a slip clutch coupled to the flywheel axle and the drive assembly; providing a mounting bearing to secure the flywheel assembly to the frame such that the flywheel maintains contact with the rear wheel; and providing a power generator that converts the mechanical energy of the flywheel and converts it into electrical power. The electrical power may be stored in a battery. This battery may then be used to charge a cellular phone, an mp3 player or a laptop computer. The flywheel assembly may be detachable from the bicycle if the user has no need for any electrical power generation.

### DRAWINGS

The above-mentioned features and objects of the present disclosure will become more apparent with reference to the following description taken in conjunction with the accompanying drawings wherein like reference numerals denote like elements and in which:

FIG. 1 is a schematic of a possible embodiment of the instant disclosure;

FIG. 2 IS a schematic of an alternative embodiment of the instant disclosure;

FIG. 3 is a schematic of another alternative embodiment of the instant disclosure;

FIG. 4 is a cross sectional view a flywheel assembly, according to embodiments of the instant disclosure.

### DETAILED DESCRIPTION

The present inventor has discovered that both exercise and lowering carbon footprints can be accomplished by providing eco-friendly transport means including mechanisms to generate, transport and buffer/store energy.

In the description that follows, the present disclosure will be described in reference to a preferred embodiment that utilizes a flywheel mounted to a bicycle frame and rotated by a chain connected to the pedal assembly. The present disclosure, however, is not limited to any particular application nor is it limited by the examples described herein. Therefore, the description of the embodiments that follow are for purposes of illustration and not limitation.

A flywheel, as known in the art, is a rotating mass typically used to maintain the speed of a machine between given limits while the machine releases or receives energy at a varying rate. A flywheel is an energy storage device. It stores energy as its speed increases, and gives up energy as the speed decreases. The specifications of the machine usually determine the allowable range of speed and the required energy interchange.

The present inventor has discovered that the mechanical energy produced by a flywheel may be converted to electrical energy. The converted electrical energy can then be stored in a battery. The battery may be adapted to charge or recharge a number of different devices.

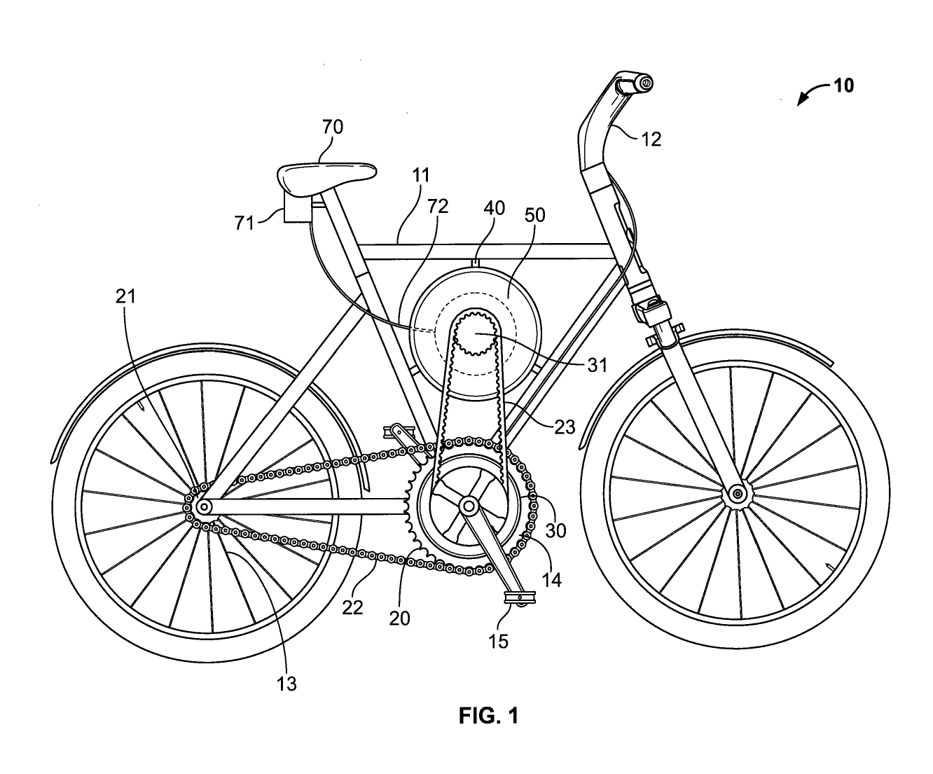

Referring now to FIG. 1, there is shown a schematic of a bicycle with a flywheel mounted between the rider's legs. The bicycle 10 comprises a frame assembly 11, a handlebar assembly 12, a wheel assembly 13, and a drive assembly 14. The handlebar assembly 12 is rotatably mounted on the frame assembly 11.

The drive assembly 14 comprises sprockets 20 and 21, and pedal 15. Sprocket 20 is rotatably connected to a midpoint of frame assembly 11 and driven by the pedal 15. Sprocket 21 is part of the drive assembly that attaches to the wheel assembly 13. Chain 22 rotates around the periphery of the sprocket 20 and sprocket 21 when pedal 15 is actuated by a rider. As a result, sprocket 20 transmits rotary motion to sprocket 21. When rotary motion is provided to sprocket 21, it causes the rotation of wheel 13.

A flywheel assembly 50 is mounted to frame assembly 11 by a plurality of mounting brackets 40. Flywheel (not shown) is enclosed inside casing of flywheel assembly 50. The drive assembly further comprises sprocket 30 rotatably connected to a midpoint of frame assembly 11 and driven by the pedal 15. An additional sprocket 31 is rotatably attached to flywheel. Chain 23 rotates around the periphery of sprockets 30 and sprocket 31 when pedal 15 is actuated by a rider. As a result sprocket 30 transmits rotary motion to sprocket 31. When rotary motion is provided to sprocket 31, it causes the rotation of the flywheel.

A power generator 60 is connected to the flywheel on the side opposite of the sprocket 31. The rotation of the flywheel will cause the power generator to generate electrical current. The power generator is electrically connected to a battery 71 that is located underneath the bicycle seat 70. The battery 71 may be mounted to the bicycle seat 70 and/or to a piece of the frame assembly 11. The electrical connection between the battery 71 and the power generator is provided by electrical wire 72 capable of conducting electrical current. The battery 71 stores the electrical power generated by the power generator that is caused by the rotation of the flywheel. The battery may be adapted to supply the electrical energy for many different devices. The battery may be connected to an inverter (not shown) to convert the battery's DC current into AC current. Many devices can be charged either through the DC current of the battery 71 or the inverted AC current. Cell phones, mp3 players, laptop computers and radios and speakers are just a few of the devices that can be charged or powered by the present invention.

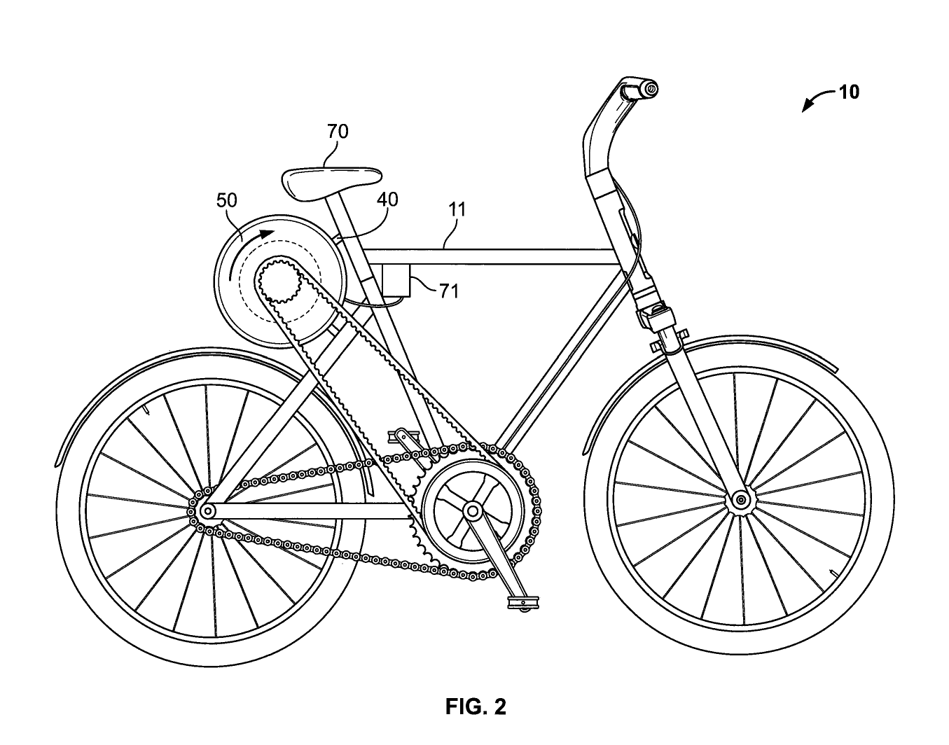

Referring to FIG. 2, an alternative embodiment of a bicycle with flywheel accessory is shown. In this embodiment, the flywheel assembly 50 is located beneath the bicycle seat 70. The flywheel (not shown) is enclosed inside the flywheel assembly 50. The flywheel assembly 50 is attached to the bicycle 10 by mounting brackets 40. The storage battery 71 is attached to the frame assembly member 11 that is located in front of the bicycle seat 70.

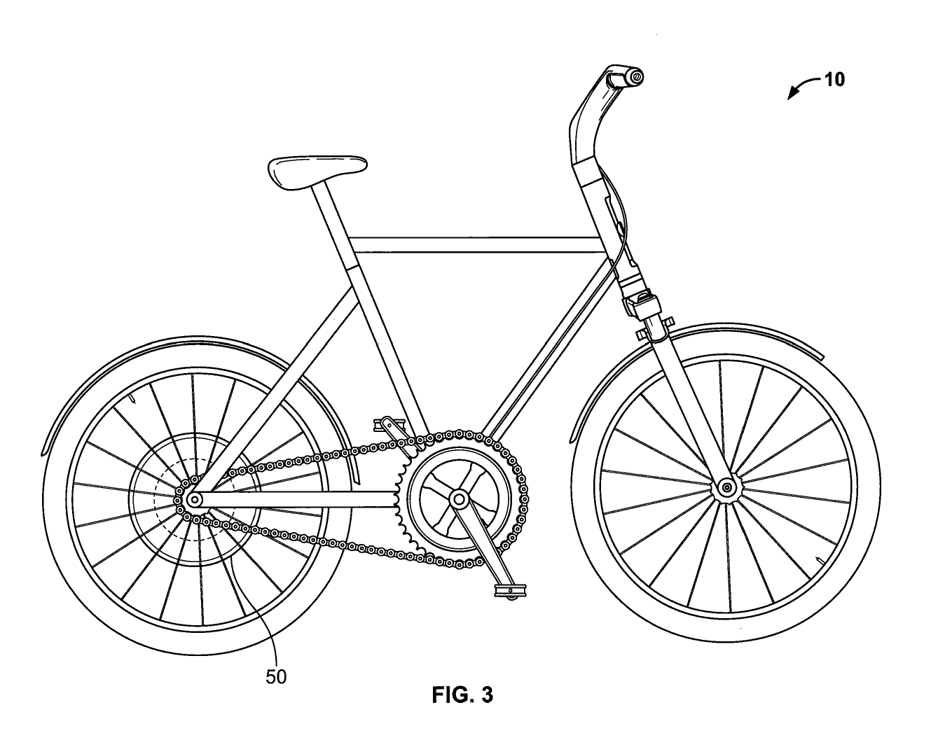

Referring to FIG. 3, another alternative embodiment of a bicycle with flywheel accessory is shown. In this embodiment, the flywheel assembly 50 is located next to the rear wheel. The flywheel (not shown) is enclosed inside the flywheel assembly 50. The flywheel assembly is attached to frame assembly and flywheel rotates around the same axle as the rear wheel.

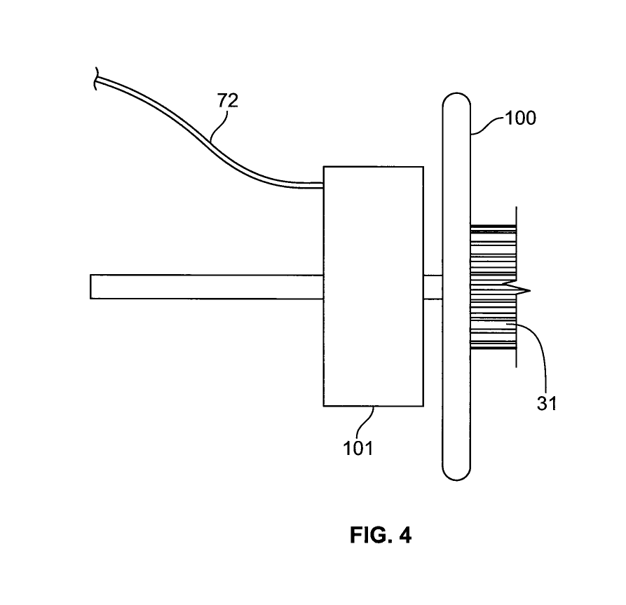

Referring to FIG. 4, the flywheel assembly is disclosed. Chain 23 is rotatably attached to sprocket 31. Sprocket 31 rotates on an axle. Attached to the axle and capable of rotating at high speeds is a flywheel 100. The sprocket 31 is on side 1 of the flywheel. The power generator 101 is located on side 2 of the axle.

The power generator converts the mechanical energy into electrical energy. Although there are many different configurations possible for a power generator, one configuration will be generally described here. A flywheel turns a shaft inside the power generator. The shaft is connected to a rectangular coil of wire through a pair of slip rings so the coil also rotates with the shaft. The coil is placed between the pole pieces of a powerful magnet. As the coil rotates, it continuously cuts the magnetic field lines linked with it. An induced current flows through the coil by the phenomenon of electromagnetic induction. The electrical energy that is created takes the form of DC current. The power generator 101 transfers this DC current through an electrical wire 72 to a storage battery 71. The storage battery 71 is capable of storing DC current for charging or recharging electrically powered devices.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to U.S. Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. An outdoor electrical charger comprising; in combination:
a flywheel;
a hand crank;
a chain connecting the flywheel and the hand crank such that the flywheel can be rotated at high speeds when the hand crank is turned;
a power generator coupled to the flywheel such that the rotation of the flywheel will cause the power generator to generate electrical power;
a storage battery electrically coupled to the power generator; and
at least an electrical output electrically coupled to the storage battery.

2. The outdoor electrical charger of claim 1, wherein the at least an electrical output is adapted to charge a cellular phone or an MP3 player.

3. The outdoor electrical charger of claim 1, wherein the at least an electrical output is adapted to charge a laptop computer.

4. The outdoor electrical charger of claim 1, further comprising at least a speaker connected to the at least an electrical output and a radio.

5. An eco-friendly bicycle comprising:
a frame assembly including, in combination:
at lest a seat assembly;
a handlebar assembly, the handlebar assembly rotatably coupled to the frame;
a drive assembly;
a wheel assembly, the wheel assembly rotatably coupled to the frame and coupled to the drive assembly;
a flywheel assembly including:
a flywheel axle, and
a flywheel attached to the flywheel axle;
a slip clutch coupled to the flywheel axle and the drive assembly;
a mounting bearing to secure the flywheel assembly to said frame such that the flywheel maintains contact with the rear wheel; and
a power generator coupled to the flywheel such that the rotation of the flywheel will cause the power generator to generate electrical power.

6. The bicycle of claim 5, further comprising a storage battery in electrical connection with the power generator.

7. The mountain bicycle of claim 6, wherein the storage battery is mounted on the frame assembly.

8. The bicycle of claim 6, wherein the storage battery is adapted to store electrical energy received from the power generator.

9. The bicycle of claim 8, further comprising an electrical charger in electrical connection with the storage battery.

10. The bicycle of claim 9, wherein the electrical charger is mounted under the seat assembly.

11. The bicycle of claim 10, wherein the electrical charger is adapted to recharge a cellular phone or an Ipod.

12. The bicycle of claim 6, further comprising speakers and a radio.

13. A method for generating electricity on a bicycle, comprising, In combination:
providing a frame assembly including:
providing a seat assembly;
providing a handlebar assembly;
providing a drive assembly; and
providing a wheel assembly, the wheel assembly rotatably coupled to the frame and coupled to the drive assembly;
providing a flywheel assembly including:
providing a flywheel axle, and
providing a flywheel attached to the flywheel axle;
providing a slip clutch coupled to the flywheel axle and the drive assembly;
providing a mounting bearing to secure the flywheel assembly to the frame such that the flywheel freely rotates around the flywheel axle; and
providing a power generator that converts the mechanical energy of the flywheel and converts it into electrical power.

14. The method of claim 13, whereby the method provides electrical power to be stored in a battery.

15. The method of claim 14, whereby the battery charges an mp3 player.

16. The method of claim 14, whereby the battery charges a cellular phone.

17. The method of claim 14, whereby the battery charges a laptop computer.

18. The method of claim 13, whereby the method provides electrical charge for a radio.

19. The method of claim 13, whereby the method provides electrical charge for a GPS device.

20. The method of claim 13, whereby an inverter is included to convert the DC power of the storage battery to AC power.
